(19) United States
(12) Patent Application Publication
(10) Pub. No.: US 2019/0381406 A1
(43) Pub. Date: Dec. 19, 2019

(54) GAME SYSTEM USING VEHICLE DRIVING INFORMATION AND METHOD OF PROVIDING GAME SERVICE IN VEHICLE

(71) Applicant: LG Electronics Inc., Seoul (KR)

(72) Inventors: Jun Young JUNG, Seoul (KR); Hyunkyu KIM, Seoul (KR); Kibong SONG, Seoul (KR); Chul Hee LEE, Seoul (KR); Sangkyeong JEONG, Seoul (KR)

(21) Appl. No.: 16/557,546

(22) Filed: Aug. 30, 2019

(30) Foreign Application Priority Data
Aug. 20, 2019 (KR) 10-2019-0101987

(51) Int. Cl. A63F 13/65; A63F 13/803; A63F 13/211; A63F 13/216; A63F 13/213; G06T 7/70; G06T 11/00

(52) U.S. Cl. CPC A63F 13/65; A63F 13/803; A63F 13/211; A63F 13/216; A63F 13/213; G06T 7/70; G06T 2207/30252; A63F 2300/8017; A63F 2300/105; A63F 2300/1087; A63F 2300/205; A63F 2300/69; G06T 11/00

(57) ABSTRACT

A method for providing a game service is disclosed. The method includes the actions of connecting, by one or more of a game system in a vehicle and a game console, the game system and the game console. The actions further include obtaining, by one or more of the game system and the game console, first data related to the vehicle. The actions further include, determining, by one or more of the game system and the game console, one or more of vehicle information that is related to the vehicle, vehicle driving information that is related to driving of the vehicle, and user information that is related to a user of the game console in the vehicle. The actions further include, providing the game service to the user of the game console through processing data related to a game played through the game console.

### CROSS-REFERENCE TO RELATED APPLICATION

The present disclosure claims priority to and the benefit of Korean Patent Application No. 10-2019-0101987, filed on Aug. 20, 2019, the disclosure of which is incorporated herein by reference in its entirety.

### FIELD

The disclosure relates to a game system providing a proper game environment using vehicle driving information and a method of providing a game service in a vehicle.

### BACKGROUND

While a vehicle drives, the passengers may feel bored or carsick. Recent research efforts to autonomous driving are fruiting many achievements. However, such self-driving technology may rather give more boredom or carsickness to passengers. This calls for services that may drive passengers to their destination in a more convenient, boredom-free way. Conventional game consoles which may be used in a vehicle may give users or passengers only monotonous, limited game services and may worsen their carsick symptom. Moreover, the game the passenger plays may be paused or terminated abnormally when the vehicle arrives at the destination.

### SUMMARY

An object of the disclosure is to provide a game system capable of providing game services reflecting the vehicle's driving state to passengers.

Another object of the disclosure is to provide a method of providing game services in a vehicle which provides game services reflecting the vehicle's driving state to passengers.

According to an innovative aspect of the subject matter described in this application, a method for providing a game service includes the actions of connecting, by one or more of a game system in a vehicle and a game console, the game system and the game console; obtaining, by one or more of the game system and the game console, first data related to the vehicle; based on the first data, determining, by one or more of the game system and the game console, one or more of vehicle information that is related to the vehicle, vehicle driving information that is related to driving of the vehicle, and user information that is related to a user of the game console in the vehicle; and, based on the one or more of the vehicle information, the vehicle driving information, and the user information, providing, by one or more of the game system and the game console, the game service to the user of the game console through processing data related to a game played through the game console.

These and other implementations can each optionally include one or more of the following features. The actions further include obtaining second data related to the game console. The first data is vehicle gyroscope data measured by a first gyroscope included in the vehicle. The second data is game console gyroscope data measured by a second gyroscope included in the game console. The actions further include determining a user seat direction that is a forward direction of the user relative to a driving direction of the vehicle by comparing the vehicle gyroscope data with the game console gyroscope data. The action of providing the game service to the user of the game console includes selecting a game to recommend to the user according to the user seat direction. The action of providing the game service to the user of the game console includes determining a likelihood of motion sickness for at least one game based on the user seat direction, a game selection screen displayed by the game console, and at least one game displayed on the game selection screen; and displaying the likelihood of motion sickness for the at least one game on the game selection. The first data includes a user photo that is image information about the user.

The action of determining one or more of the vehicle information, the vehicle driving information, and the user information includes determining whether the user feels motion sickness based on the user photo; obtaining game information that is information about the game that the user plays through the game console; learning a result of determining whether the user feels motion sickness, the game information, and the user seat direction; and determining the likelihood of motion sickness using a result of learning the result of determining whether the user feels motion sickness, the game information, and the user seat direction. The first data includes around-vehicle image data obtained by capturing images of surroundings of the vehicle. The action of providing the game service to the user of the game console includes reflecting the around-vehicle image data to an environment of the game played on the game console. The action of providing the game service to the user of the game console includes processing the around-vehicle image data into a background screen of the game played on the game console.

The first data includes vehicle gyroscope data measured by a gyroscope included in the vehicle, vehicle damper data measured by a sensor attached to a damper of the vehicle, and vehicle location data generated based on information received by a global positioning system (GPS) device included in the vehicle. The action of determining one or more of the vehicle information, the vehicle driving information, and the user information includes generating and updating location-based road data based on the vehicle gyroscope data, the vehicle damper data, and the vehicle location data. The action of providing the game service to the user of the game console includes processing a game environment of the game played on the game console based on the location-based road data. The first data includes one or more of radar measurement data, lidar measurement data, and camera measurement data. The action of determining one or more of the vehicle information, the vehicle driving information, and the user information includes generating and updating the location-based road data by learning a road state based on the first data. The first data includes route data including a curvature of a location-based route and vehicle location data generated based on information received by a GPS device included in the vehicle. The action of providing the game service to the user of the game console includes, based on the curvature being a location of the vehicle that exceeds a permitted range, reflecting the curvature to a game environment of the game played on the game console. The first data includes one or more of radar measurement data, lidar measurement data, and camera measurement data.

The actions further include determining the curvature using the first data in the location of the vehicle. The first data includes load information that is information related to a load applied to a driving unit of the vehicle and outside-vehicle image information that is obtained by capturing an image of an outside of the vehicle. The actions further include providing the game service to the user of the game console includes determining a height of a horizon based on the outside-vehicle image information; determining that the vehicle is on an ascent based on the load information being larger than a first load reference value and the height of the horizon being smaller than a first horizon reference value; determining that the vehicle is on a descent based on the load information being smaller than a second load reference value that is equal or smaller than the first load reference value and the height of the horizon being larger than a second horizon reference value that is equal or larger than the first horizon reference value; and proceeding, by the game console, with a scenario for the ascent when the vehicle is on the ascent, and proceeding, by the game console, with a scenario for the descent when the vehicle is on the descent. The first data includes a remaining arrival time that remains until the vehicle arrives at a destination. The second data includes a remaining play time that remains until the game terminates. The action of providing the game service to the user of the game console includes comparing the remaining arrival time with the remaining play time; and adjusting a number of stages of the game played on the game console based on comparing the remaining arrival time with the remaining play time.

According to an innovative aspect of the subject matter described in this application, a game system that includes an analyzing unit that is configured to determine, based on analyzing data related to a vehicle, one or more of vehicle information that is related to the vehicle, vehicle driving information that is related to driving of the vehicle, and user information that is related to a user of a game console in the vehicle; and a game supporting unit that is connected with the game console used by a passenger in the vehicle. The game supporting unit is configured to receive game data related to a game played on the game console; process the game data based on one or more of the vehicle information, the vehicle driving information, and the user information; and transmit the processed game data to the game console.

These and other implementations can each optionally include one or more of the following features. The analyzing unit is configured to determine a user seat direction that is a forward direction of the passenger relative to a driving direction of the vehicle. The game supporting unit is configured to process the game data to allow the game console to recommend, to the passenger, a game selected based on the user seat direction. The analyzing unit is configured to determine a likelihood of motion sickness that is a likelihood of the passenger feeling motion sickness, based on a user seat direction that is a forward direction of the passenger relative to the driving direction of the vehicle, information about the game played on the game console, and information about whether the passenger feels motion sickness. The game supporting unit is configured to process the game data to display the likelihood of motion sickness for at least one game on a game selection screen based on the user seat direction, the game selection screen displayed on the game console, and the game displayed on the game selection screen.

The analyzing unit is configured to determine a road state in a location where the vehicle is driving based on the first data; and provide the road state to the game supporting unit. The game supporting unit is configured to process the game data to allow the road state to be reflected to an environment of the game played on the game console. The analyzing unit is configured to obtain image information about surroundings of the vehicle; and provide the image information to the game supporting unit. The game supporting unit is configured to process the game data to allow the image information about the surroundings of the vehicle to be reflected to an environment of the game played on the game console. The analyzing unit is configured to compare a remaining arrival time that remains until the vehicle arrives at a destination with a remaining play time that remains until the game terminates; and provide, to the game supporting unit, a result of comparing the remaining arrival time with the remaining play time. The game supporting unit is configured to process the game data to reduce the number of stages of the game played on the game console when the remaining arrival time is shorter than the remaining play time and to increase the number of stages of the game played on the game console when the remaining arrival time is longer than the remaining play time.

### BRIEF DESCRIPTION OF THE DRAWINGS

FIG. 1 is a schematic of an example configuration to which a game service and method of providing a game service apply.

FIG. 2 is a block diagram of an example game system as shown in FIG. 1.

FIG. 3 is a block diagram of an example game console connected with a game system as shown in FIG. 1.

FIG. 4 is a flowchart of an example process for providing a game service.

FIG. 5 is a flowchart of an example process for determining the direction of a seat in a process of providing a game service.

FIG. 6 illustrates an example process for recommending a game depending on the direction of a seat in a process of providing a game service.

FIG. 7 is a flowchart of an example process for determining the likelihood of motion sickness in a process of providing a game service.

FIG. 8 illustrates an example of notifying a user of the likelihood of motion sickness for a particular game in a process of providing a game service.

FIG. 9 is a flowchart of an example process for adjusting a game environment depending on the state of a road in a process of providing a game service.

FIG. 10 is a flowchart of an example process for determining the state of a road in a process of providing a game service.

FIG. 11 is a flowchart of an example process for determining the curvature of a route in a process of providing a game service.

FIG. 12 is a flowchart of an example process for determining the slope of a route in a process of providing a game service.

FIG. 13 is a flowchart of an example process for changing game scenarios according to the remaining time to a destination in a method of providing a game service.

### DETAILED DESCRIPTION

It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

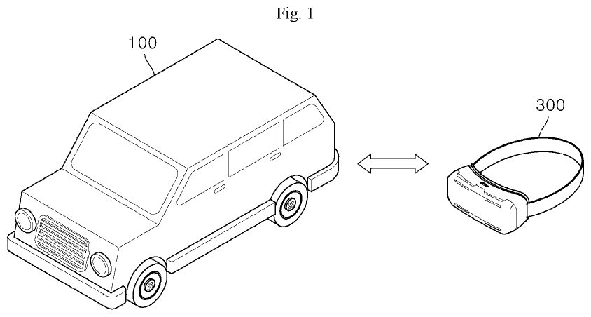

FIG. 1 is a schematically view illustrating an example configuration to which a game service and method of providing a game service apply.

A vehicle 100 includes a game system. The game system included in the vehicle 100 may grasp the vehicle's driving information. The game system included in the vehicle 100 may be connected with a game console 300. The game system may process a game environment, which the connected game console 300 provides, based on the grasped vehicle driving information.

The vehicle driving information is not necessarily limited to information directly related to the driving of the vehicle 100 but rather means all information related, directly or indirectly, to the vehicle and/or a passenger of the vehicle when the vehicle is driving and/or temporarily stops. For example, the vehicle driving information may include at least one or more of information related to the driving of the vehicle 100, information related to the road on which the vehicle 100 drives, information about the location of a user (e.g., a passenger) of the game console 300 inside the vehicle 100, and information about the user's state.

Game environment means all forms of sensory information provided to the user in the game the game console implements. For example, the game environment may be information about recommended games the game console provides to the user or may be one of scenarios of the game played on the game console, game background screens, or kinds of games.

The vehicle 100 may collectively denote not only a vehicle with only an internal combustion engine, a hybrid vehicle with both an internal combustion engine and an electric motor, and an electric vehicle with only an electric motor, but also a train or motorcycle.

The vehicle 100 may be an autonomous driving vehicle. As used herein, autonomous driving means self-driving technology, and autonomous driving vehicle means a vehicle driving with a user's no or minimum control. For example, autonomous driving may encompass all of such techniques as staying in a driving lane, automatic speed control, e.g., adaptive cruise control, autonomous driving along a predetermined route, and automatically setting a route and directing to a destination when the display is set.

The vehicle may be associated with any artificial intelligence (AI) modules, drones, unmanned aerial vehicles, robots, augmented reality (AR) modules, virtual reality (VR) modules, or 5th generation (5G) mobile communication devices.

The game console 300 may be associated with the game system included in the vehicle 100. The game console 300 may provide information about games the game console 300 provides and may provide a proper game service to the user (e.g., a passenger of the vehicle) according to the game environment (e.g., a background screen of the game) processed by the game system. The game console 300 may be separated from the vehicle 100 as shown in FIG. 1 or may be mounted in the vehicle 100 (e.g., the game console 300 may be a device using a window of the vehicle as its display).

The game console 300 may be an extended reality (XR) device to which XR technology has applied. XR collectively refers to virtual reality (VR), augmented reality (AR), and mixed reality (MR). VR is computer graphics technology that provides the real-world objects or background in a computer graphics (CG) image. AR provides a virtual CG image overlaid on a real-world object image, along with the real-world object image. MR mixes and provides the real-world with virtual objects.

MR is similar to AR in that it provides the real-world objects together with virtual objects. However, while AR takes virtual objects as supplementing real-world objects, MR treats virtual objects and real-world objects equally.

FIG. 1 illustrates an example VR game console separated from the vehicle, but the game console 300. For example, the game console 300 may be any of various kinds of mobile devices, e.g., mobile phones, tablet PCs, or laptop computers, which are separated from the vehicle. The game console 300 may include a device displaying images on a window of the vehicle in various forms, e.g., as does a head-up display (HUD), or a device adopting, as its display, a window of the vehicle which has been implemented with a display panel.

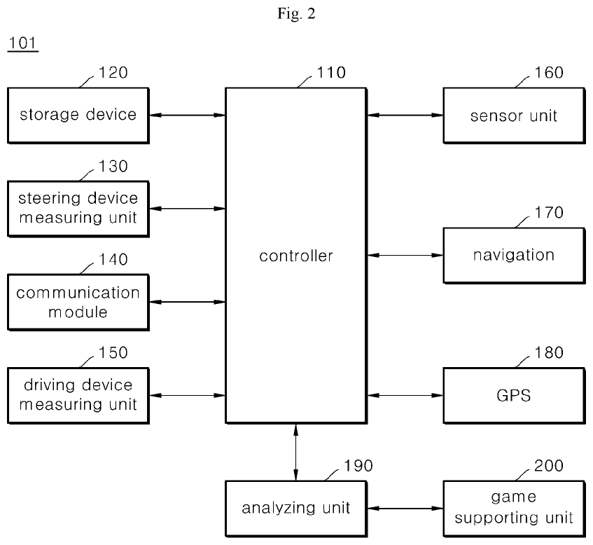

FIG. 2 is a block diagram schematically illustrating a configuration of a game system as shown in FIG. 1. A game system 101 may include a controller 110, a storage device 120, a steering device measuring unit 130, a communication module 140, a driving device measuring unit 150, a sensor unit 160, a navigation 170, a global positioning system (GPS) device 180, an analyzing unit 190, and a game supporting unit 200.

The controller 110 may receive various pieces of information from at least one or more of the storage device 120, the steering device measuring unit 130, the communication module 140, the driving device measuring unit 150, the sensor unit 160, the navigation 170, and the GPS device 180 and may provide the received information to the analyzing unit 190. The controller 110 may control at least one or more of various electronic devices of the vehicle including the above-described devices.

The controller 110 may include at least one processing unit and memory. The processing unit may include, e.g., a central processing unit (CPU), a graphic processing unit (GPU), a microprocessor, an application specific integrated circuit (ASIC), or field programmable gate arrays (FPGA). The processing unit may have a plurality of cores. The memory may be a volatile memory (e.g., a random access memory (RAM), a non-volatile memory (e.g., a read-only memory (ROM) or flash memory), or a combination thereof.

The storage device 120 may store various data necessary for the analyzing unit 190 to perform machine learning. Specifically, the storage device 120 may store data received from at least one or more of the steering device measuring unit 130, the communication module 140, the driving device measuring unit 150, the sensor unit 160, the navigation 170, and the GPS device 180. In this case, each piece of data may be stored along with the time that the data was gathered or may be stored with other data in association with each other.

The steering device measuring unit 130 may measure the state of the vehicle's steering device (e.g., the angle of the steering device from a middle position) and provide information about the state of the steering device to the controller 110.

The communication module 140 may receive, e.g., traffic information from a cloud computer or other various servers. The communication module 140 may use at least one or more of various communication schemes or standards, such as global system for mobile communication (GSM), code division multiple access (CDMA), long-term evolution (LTE), 5th generation (5G), wireless local area network (WLAN), wireless-fidelity (Wi-Fi), Bluetooth™, radio frequency identification (RFID), infrared data association (IrDA), ZigBee, or near field communication (NFC).

The driving device measuring unit 150 may measure information about the load applied to the driving device of the vehicle, including, e.g., a motor and/or an engine, and provide the load information about the driving device to the controller 110.

The sensor unit 160 may gather information about the ambient environment of the vehicle and/or information about the vehicle itself via various sensors and provide the gathered ambient environment information and/or vehicle information to the controller 110. For example, the sensor unit 160 may include at least one or more of a camera for obtaining an image of the surroundings of the vehicle, a camera for obtaining an image of the inside of the vehicle, a camera for capturing passengers inside the vehicle and/or the user of the game console, a microphone for obtaining a sound from the surroundings and/or inside of the vehicle, a gyroscope for obtaining information about the posture of the vehicle, an acceleration sensor for measuring the acceleration of the vehicle, a distance measuring sensor, e.g., Radar or Lidar, for measuring the distance between an ambient object and the vehicle, and a sensor for measuring the physical force applied to a device, e.g., damper, of the vehicle.

The navigation 170 may provide information about the vehicle's predicted driving route to the destination to the controller 110.

The GPS device 180 may provide GPS information and/or information about the current location of the vehicle, which is based on the GPS information, to the controller 110.

The analyzing unit 190 may grasp at least one or more of the vehicle's state, the vehicle's ambient state, the state of the road along the predicted driving route or the current location of the vehicle, and the state of the vehicle passenger by analyzing various pieces of information received via the controller 110. For example, the analyzing unit 190 may include at least one processing unit and memory. Here, the processing unit may be, e.g., a neural network processing unit (NPU) or digital signal processor (DSP) implemented to be able to more smoothly perform machine learning or processing related to artificial intelligence (AI). The processing unit may include a central processing unit (CPU), a graphic processing unit (GPU), a microprocessor, an application specific integrated circuit (ASIC), or field programmable gate arrays (FPGA). The processing unit may include a plurality of cores. The memory may be a volatile memory (e.g., a random access memory (RAM), a non-volatile memory (e.g., a read-only memory (ROM) or flash memory), or a combination thereof.

The game supporting unit 200 may recommend a proper game to the user (e.g., a passenger of the vehicle) of the game console or adequately process the environment of the game played on the game console, based on, e.g., game information received from the game console (300 of FIG. 1) and information analyzed by the analyzing unit. To that end, the game supporting unit 200 may be connected with the game console. The game supporting unit 200 may include a communication module for connecting to the game console. The game supporting unit 200 may provide various kinds of data (e.g., various kinds of information the controller 110 has obtained) to the game console (300 of FIG. 1).

Specific operations of the analyzing unit 190 and the game supporting unit 200 are described below with reference to FIGS. 4 to 13.

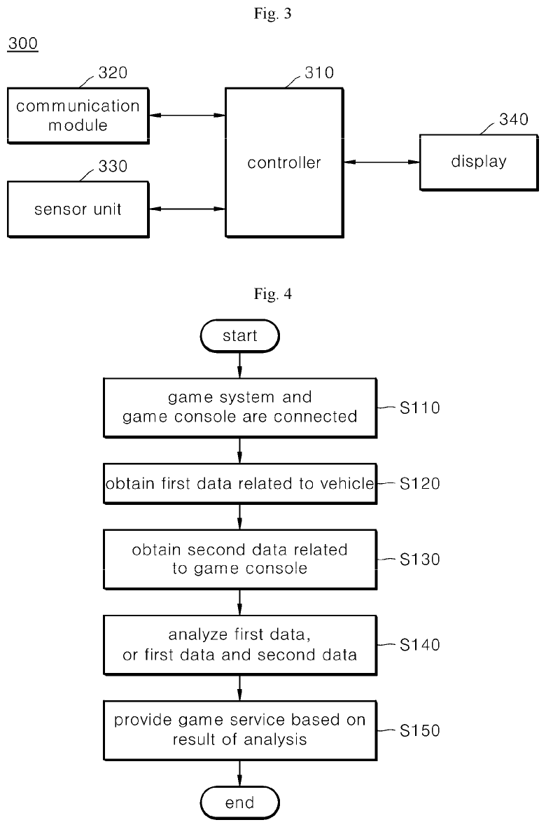

FIG. 3 is a view schematically illustrating a configuration of a game console connected with a game system, as shown in FIG. 1. The game console 300 may include a controller 310, a communication module 320, a sensor unit 330, and a display 340.

The controller 310 may transfer information received from the sensor unit 330 to the game system (e.g., 101 of FIG. 2) of the vehicle via the communication module 320. The controller 310 may control the display 340 to display, on the display 340, various game environments according to messages or data received from the game system of the vehicle. At this time, the controller 310 may control the display 340 to display, on the display 340, images or videos generated by XR technology. The controller 310 may provide the game system (101 of FIG. 2) with information about the game being played on the game console (e.g., the expected play time remaining until the game ends or information about the kind of game). The controller 310 may control the display 340 to play game on the display in response to, e.g., the user's input. Specific operations of the controller 310 are described below with reference to FIGS. 4 to 13.

The controller 310 may include at least one processing unit and memory. The processing unit may include, e.g., a central processing unit (CPU), a graphic processing unit (GPU), a microprocessor, an application specific integrated circuit (ASIC), or field programmable gate arrays (FPGA). The processing unit may have a plurality of cores. The memory may be a volatile memory (e.g., a random access memory (RAM), a non-volatile memory (e.g., a read-only memory (ROM) or flash memory), or a combination thereof.

Although not shown, the game console 300 may include additional storage. The storage includes, but is not limited to, magnetic storage or optical storage. The storage may store computer-readable commands for implementing a particular game and may also store other computer-readable commands for implementing an operating system (OS) or application programs. The computer-readable commands stored in the storage may be loaded onto the memory of the controller 310 to be executed by the processing unit of the controller 310.

The communication module 320 may connect to the game system (e.g., 101 of FIG. 2) of the vehicle. The communication module 320 may transmit information obtained by the sensor unit 330 to the vehicle's game system and receive various messages or data from the vehicle's game system.

The sensor unit 330 may gather information about the ambient environment of the game console 300 or information about the game console 300 itself and provide the gathered information to the controller 310. The sensor unit 330 may include at least one or more of a gyroscope for obtaining information about the posture of the game console and an acceleration sensor for measuring the acceleration of the game console.

The display 340 may display various images to allow the user to play game under the control of the controller 310. In a case where the game console 300 is a device separated from the vehicle as described above, the display 340 may be a component included in the game console 300. In some implementations, the display 340 may be an accessory component of the vehicle, e.g., a window of the vehicle.

FIG. 4 is a flowchart illustrating operations of a method of providing a game service. Each step of FIG. 4 may be performed by at least one or more of a game console (e.g., 300 of FIG. 1 or 3) and a game system (e.g., 101 of FIG. 2) included in a vehicle.

First, the game system and the game console may connect (pair) to each other (step S110).

Next, first data related to the vehicle may be obtained (step S120). Here, the first data may include at least one or more of image data of the surroundings of the vehicle, image data of the inside of the vehicle, image data taken of the user of the game console inside the vehicle, sound data of the surroundings of the vehicle, sound data of the inside of the vehicle, data of the vehicle gyroscope providing information about the posture of the vehicle, vehicle acceleration data indicating the acceleration of the vehicle, data of the distance between the vehicle and an ambient object of the vehicle, damper data related to the damper of the vehicle, vehicle steering device data related to the state of the steering device of the vehicle, load data related to the load of the motor or engine of the vehicle, driving route data related to the driving route of the vehicle, vehicle location data indicating the current location of the vehicle, and destination remaining time data related to the time left until the vehicle arrives at the destination. Step S120 may be obtained as the analyzing unit (190 of FIG. 2) of the game system obtains first data through the controller (110 of FIG. 2). In some implementations, step S120 may be carried out as the controller (310 of FIG. 3) of the game console (300 of FIG. 1 or 3) receives the first data from the game system (101 of FIG. 2) through the communication module (320 of FIG. 3).

Next, second data related to the game console may be obtained (step S130). Here, the second data may include at least one or more of game console gyroscope data related to the posture of the game console, game console acceleration data related to the acceleration of the game console, and the remaining play time data indicating the time left until the game played on the game console terminates. Step S130 may be performed as the analyzing unit (190 of FIG. 2) of the game system obtains the second data from the game console (300 of FIG. 1 or 3) through the game supporting unit (200 of FIG. 2). In some implementations, step S130 may be carried out as the controller (310 of FIG. 3) of the game console receives the second data from the sensor unit (330 of FIG. 3) or the controller (310 of FIG. 3) by itself gathers the second data.

Then, the first data, or the first data and second data, may be analyzed to grasp at least one or more of information related to the vehicle itself, information related to the vehicle's driving, and information related to the user using the game console in the vehicle (step S140). For example, the game system may analyze the first data, or the first data and second data, thereby grasping at least one or more of the location of the user of the game console inside the vehicle, the direction of the user's seat, whether the passenger feels carsick and/or the degree of carsickness the passenger feels, the curvature of the vehicle's driving route, the state of the road on which the vehicle is driving, whether the vehicle's driving route has a slope, and the time taken for the vehicle to arrive at the destination. Step S140 may be performed through the analyzing unit (190 of FIG. 2) of the game system (101 of FIG. 2). In some implementations, step S140 may be conducted by the controller (310 of FIG. 3) of the game console (300 of FIG. 1 or 3).

Subsequently, the game-related data may be processed based on the results of analysis of step S140, and a game service may be provided to the user of the game console (step S150).

For example, the game system and game console may recommend an adequate game to the user of the game console, provide information about the likelihood of the user feeling motion sickness or other inconvenience when a certain game is played, process a game background screen, process a game scenario or game stage, or adjust the time left until the game ends.

Based on, e.g., a movement of an object detected from around the vehicle, the game system and game console may grasp the degree of danger due to the detected object by an AI algorithm and process the game scenario or background according to the degree of danger. For example, where another vehicle passes by the vehicle the game user is in, the driving route of the other vehicle may be displayed as a structure or border (e.g., a centerline) to which the character (e.g., a vehicle in a driving game) controlled by the user of the game console cannot proceed in the game.

The game system or game console the circumstances occurring around the vehicle by an AI algorithm and based on, e.g., the state of the vehicle or movement of the object detected from around the vehicle and reflect the circumstances to the game scenario or produce them as a game background screen. For example, the game system or game console may enable a particular game item to show up in the position where a passenger other than the user of the game console in the vehicle gets on or off or produce the circumstance where the vehicle loads or unloads as a game background screen.

Step S150 may be performed through the analyzing unit (190 of FIG. 2) of the game system (101 of FIG. 2). In some implementations, step S150 may be conducted by the controller (310 of FIG. 3) of the game console (300 of FIG. 1 or 3).

Described below is an example in which a method of providing a game service is performed primarily by the game supporting unit (200 of FIG. 2) and/or the analyzing unit (190 of FIG. 2) of the game system. However, all of the steps performed by the game supporting unit (200 of FIG. 2) and/or the analyzing unit (190 of FIG. 2) of the game system may also be carried out by the controller (310 of FIG. 3) of the game console. In some implementations, only some of the steps performed by the game supporting unit (200 of FIG. 2) and/or the analyzing unit (190 of FIG. 2) of the game system may be carried out by the controller (310 of FIG. 3) of the game console.

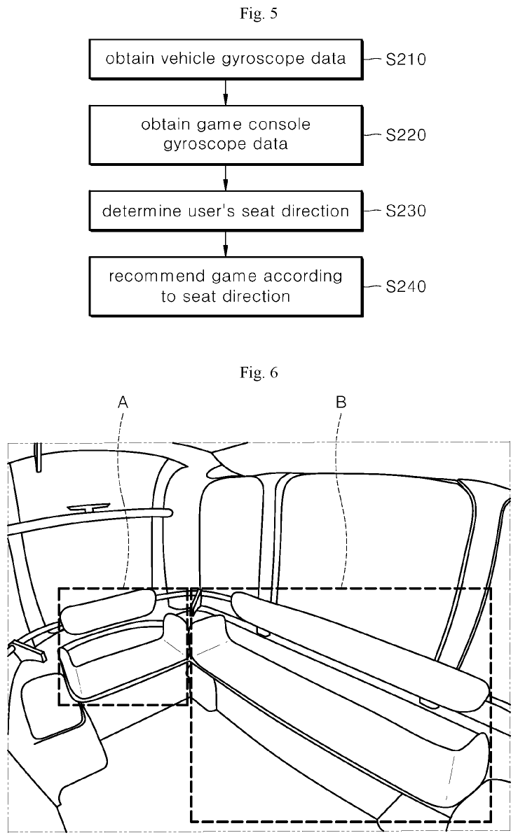

FIG. 5 is a flowchart illustrating operations of a method of determining the direction of a seat in a method of providing a game service.

First, the analyzing unit (190 of FIG. 2) may obtain the vehicle's gyroscope data (step S210). For example, the analyzing unit (190 of FIG. 2) may obtain data measured by the gyroscope of the sensor unit (160 of FIG. 2) through the controller (110 of FIG. 2)

Next, the analyzing unit (190 of FIG. 2) may obtain gyroscope data of the game console (300 of FIG. 1 or 3) (step S220). For example, the analyzing unit (190 of FIG. 2) may obtain data measured by the gyroscope of the sensor unit (330 of FIG. 3) of the game console (300 of FIG. 3) through the game supporting unit (200 of FIG. 2).

Then, the analyzing unit (190 of FIG. 2) may compare the gyroscope data of the vehicle with the gyroscope data of the game console, thereby determining the seat direction of the user of the game console (step S230). For example, the analyzing unit (190 of FIG. 2) may determine the direction of the user's seat by comparing the direction of the vehicle grasped using the vehicle's gyroscope data with the direction of the user of the game console grasped using the gyroscope data of the game console.

Subsequently, the analyzing unit (190 of FIG. 2) may provide information about the user's seat direction to the game supporting unit (200 of FIG. 2), and the game supporting unit (200 of FIG. 2) may transmit the data to the game console (300 of FIG. 1 or 3) so that the game according to the seat direction is provided through the game console (300 of FIG. 1 or 3) (step S240).

As set forth above, all or some of steps S210 to S240 may be performed by the controller (310 of FIG. 3) of the game console. Steps S210 to S230 may also be carried out by the game supporting unit (200 of FIG. 2) of the game system.

Although not shown, the location of the user of the game system may be grasped by a method other than the method of FIG. 5. For example, the analyzing unit (190 of FIG. 2) may grasp the user's location in the vehicle, based on, e.g., a sensor attached to the seat in the vehicle or image data about the inside of the vehicle which is obtained by the sensor unit (160 of FIG. 2), and the analyzing unit (190 of FIG. 2) may grasp the user's seat direction based on the user's location.

FIG. 6 is a view illustrating an example method of recommending a game depending on the direction of a seat in a method of providing a game service.

For vehicles, particularly autonomous vehicles, a passenger's seat direction may be a forward direction (A of FIG. 6) or a lateral direction (B of FIG. 6) relative to the vehicle's driving direction.

In some implementations, where the seat direction of the user of the game console is a lateral direction relative to the vehicle's driving direction, the user may be recommended a game (e.g., a snowboard game) having the same environment as the user moves aside. Where the seat direction of the user of the game console is a forward direction relative to the vehicle's driving direction, the user may be recommended a game (e.g., a car driving game) having the same environment as the user moves forward.

Where the seat direction of the user of the game console is a reverse direction relative to the vehicle's driving direction, the user may be recommended a game (e.g., a car driving game) having the same environment as the user moves forward, thereby allowing the user to feel as if she drives forward on the game. This way may minimize the motion sickness that the passenger (e.g., the user of the game console) may feel.

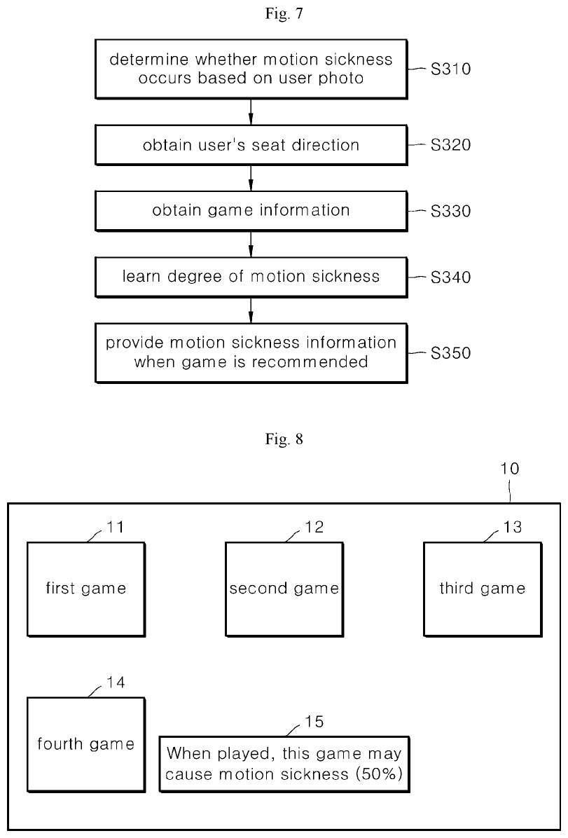

FIG. 7 is a flowchart illustrating operations of a method of determining the likelihood of motion sickness in a method of providing a game service.

First, the analyzing unit (190 of FIG. 2) may obtain the user's photo and determine whether the user feels carsick based on the user's photo (step S310). For example, the analyzing unit (190 of FIG. 2) may obtain the photo of the user of the game console, as obtained by the camera of the sensor unit (160 of FIG. 2), through the controller (110 of FIG. 2). The analyzing unit (190 of FIG. 2) may determine whether the user of the game console feels carsick through an artificial intelligence (AI) algorithm which is capable of perceiving, e.g., the user's sentiment.

Next, the analyzing unit (190 of FIG. 2) may obtain information about the user's seat direction (step S320). The same method as that described above in connection with FIG. 5 may be applied to obtain the information about the user's seat direction.

Then, the analyzing unit (190 of FIG. 2) may obtain game information (step S330). For example, the analyzing unit (190 of FIG. 2) may obtain information about the kind of game being currently played from the game console (300 of FIG. 1 or 3) through the game supporting unit (200 of FIG. 2).

Thereafter, the analyzing unit (190 of FIG. 2) may learn the relationship between the degree of motion sickness the user feels and the user's seat direction and game information (e.g., information about the kind of game) (step S340).

As described above, steps S310 to S350 may be performed by the controller (310 of FIG. 3) of the game console or by the game supporting unit (200 of FIG. 2) of the game system.

FIG. 8 is a view illustrating an example of notifying a user of the likelihood of motion sickness for a particular game in a method of providing a game service.

As shown in FIG. 8, the game console may display a plurality of pieces of game information 11, 12, 13, and 14 on a game selection screen 10. In some implementations, if the likelihood of feeling motion sickness when a fourth game is played in the current seat direction of the user of the game console is determined to be 50%, information indicating that motion sickness may occur if the fourth game is played may be displayed on an area 15 of the selection screen 10, so that information necessary for selecting game may be provided to the user.

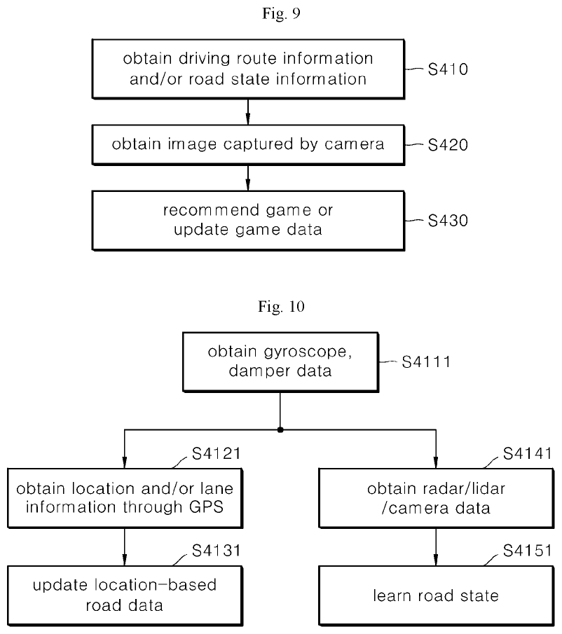

FIG. 9 is a flowchart illustrating operations of a method of adjusting a game environment depending on the state of a road in a method of providing a game service.

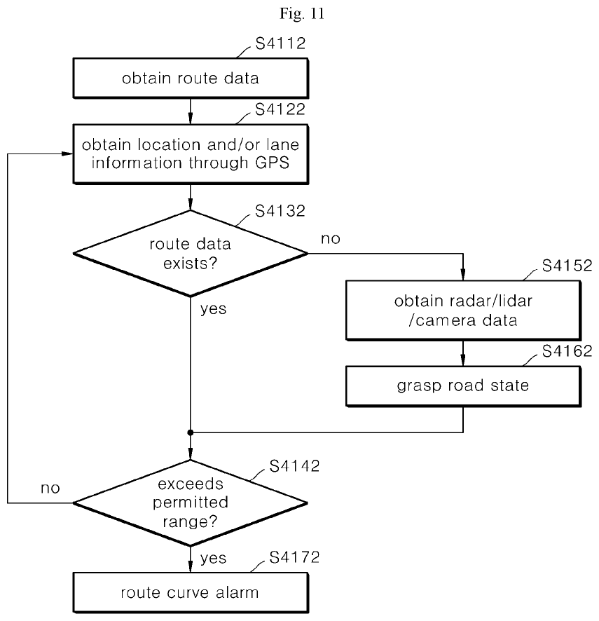

First, the analyzing unit (190 of FIG. 2) may obtain driving route information and/or road state information (step S410). The driving route information may be obtained from a navigation (170 of FIG. 2) through the controller (110 of FIG. 2). How curvy the road is (e.g., the curvature of the road) and the state or gradient of the road may be grasped by learning. Specific methods of grasping the curvature, state, and gradient of the road are described below with reference to FIGS. 10 to 12. Information about, e.g., the grasped road curvature, state (e.g., how uneven the road is), and gradient, may be matched with GPS location information and stored.

Next, the analyzing unit (190 of FIG. 2) may obtain a camera-captured image for the external environment on the vehicle's driving route (step S420). For example, the analyzing unit (190 of FIG. 2) may obtain a captured image for the outside of the vehicle as obtained by the camera of the sensor unit (160 of FIG. 2) through the controller (110 of FIG. 2).

Next, the user may be recommended a game or game data may be processed based on at least one or more of the camera-captured image for the external environment on the driving route and the information regarding, e.g., a slope way, curve, or uneven road on the driving route grasped in step S410 (step S430).

For example, the camera-captured image for the external environment on the driving route may be allowed to be the background screen of the game. Specifically, when the vehicle drives through a snow-covered mountain, the snow-covered mountain may become the background screen of the game on the game console. When the vehicle drives on a coastal road, the coastline may become the background screen of the game on the game console, or a coastal road driving game may be played on the game console. Where the vehicle passes on a railroad, the game console may reflect train-related content onto the game scenario or play a train-related game.

The game data may be processed so that such elements as curves, irregularities, or slope way of the road on the driving route are reflected to the game content. When game data related to a particular driving route is previously produced, and the user of the game console attempts to move along the particular driving route, a game to which the pre-produced game data has been applied may be recommended to the user of the game console.

As described above, steps S310 to S350 may be performed by the controller (310 of FIG. 3) of the game console or by the game supporting unit (200 of FIG. 2) of the game system.

FIG. 10 is a flowchart illustrating operations of a method of determining the state of a road in a method of providing a game service.

First, the analyzing unit (190 of FIG. 2) may obtain vehicle gyroscope data and damper data (step S4111). For example, the analyzing unit (190 of FIG. 2) may obtain the vehicle gyroscope data and damper data through, e.g., a sensor placed on the damper and the gyroscope of the sensor unit (160 of FIG. 2), through the controller (110 of FIG. 2).

Next, the analyzing unit (190 of FIG. 2) may obtain the precise location and/or lane information about the vehicle based on, e.g., GPS information (step S4121). For example, the analyzing unit (190 of FIG. 2) may obtain, e.g., GPS information obtained by the GPS device (180 of FIG. 2) and/or distances to ambient objects, obtained by the sensor unit (160 of FIG. 2), through the controller (110 of FIG. 2) and may grasp, e.g., the precise location of the vehicle and/or lane information using the obtained information.

Then, the analyzing unit (190 of FIG. 2) may store road data in association with the lane information and/or location of vehicle obtained in step S4121 or update the stored road information (step S4131).

The analyzing unit (190 of FIG. 2) may obtain data using various sensors (e.g., Radar, Lidar, or camera) of the sensor unit (160 of FIG. 2) of the vehicle (step S4141).

Thereafter, the analyzing unit (190 of FIG. 2) may learn the information obtained in step

S4111 and the data obtained in step S4141, thereby grasping the state (e.g., the degree of irregularity of the road) of the road (step S4151).

As described above in connection with FIG. 9, the game environment may be processed using the irregularity information about the road on the driving route. For example, where the user passes a location where the degree of irregularity of road is high, the game supporting unit (200 of FIG. 2) may processed the game environment so that such is reflected onto the game.

As described above, steps S4111 to S4151 may be performed by the controller (310 of FIG. 3) of the game console or by the game supporting unit (200 of FIG. 2) of the game system.

FIG. 11 is a flowchart illustrating operations of a method of determining the curvature of a route in a method of providing a game service.

First, the analyzing unit (190 of FIG. 2) may obtain route data (step S4112). The route data may include the degree of curve (e.g., curvature) of the route in each location. For example, the analyzing unit (190 of FIG. 2) may obtain the route data stored in the storage device (120 of FIG. 2) through the controller (110 of FIG. 2).

Next, the analyzing unit (190 of FIG. 2) may obtain the precise location and/or lane information about the vehicle based on, e.g., GPS information (step S4122). For example, the analyzing unit (190 of FIG. 2) may obtain, e.g., GPS information obtained by the GPS device (180 of FIG. 2) and/or distances to ambient objects, obtained by the sensor unit (160 of FIG. 2), through the controller (110 of FIG. 2) and may grasp, e.g., the precise location of the vehicle and/or lane information using the obtained information.

Next, the analyzing unit (190 of FIG. 2) may determine whether there is route data in the current location of the vehicle (step S4132).

Unless there is determined to be route data in step S4132, the analyzing unit (190 of FIG. 2) may obtain various pieces of information (e.g., information measured or obtained by Radar, Lidar, and camera) obtained by the sensor unit (160 of FIG. 2) through the controller (110 of FIG. 2) (step S4152).

Next, the analyzing unit (190 of FIG. 2) may grasp the state of the route (e.g., the curvature of the route) based on the obtained information (step S4162). In this case, the analyzing unit (190 of FIG. 2) may grasp the state of the route through an AI algorithm. The analyzing unit (190 of FIG. 2) may learn the correlation between the route curvature and the obtained information.

If there is determined to be route information in step S4132 or the route state is grasped in step S4162, the analyzing unit (190 of FIG. 2) may determine whether the route curvature exceeds a permitted range (step S4142). Here, the permitted range may be a threshold range for reflecting a curve, which may exist on the route, to the game.

If the route curvature is determined to exceed the permitted range in step S4142, a route curve alarm may be generated (step S4172). The route curve may be reflected onto the game environment which is provided to the user of the game console in response to the route curve alarm. For example, where a car driving game is played on the game console, the game data may be processed to allow the curvature of the road on which the vehicle is driving to be similar to the curvature of the actual route.

As described above, steps S4112 to S4172 may be performed by the controller (310 of FIG. 3) of the game console or by the game supporting unit (200 of FIG. 2) of the game system.

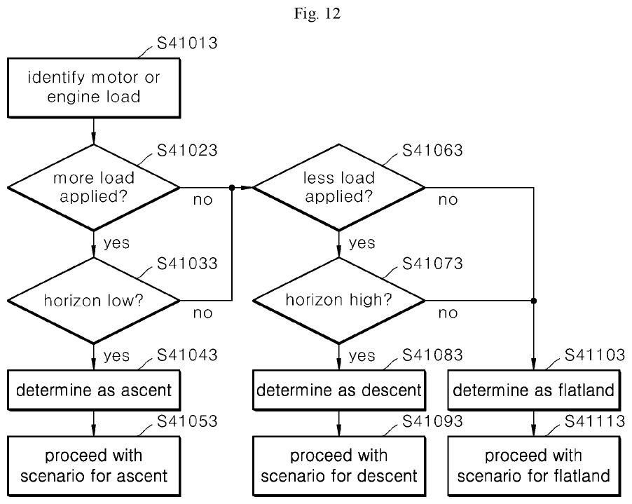

FIG. 12 is a flowchart illustrating operations of a method of determining the slope of a route in a method of providing a game service.

First, the analyzing unit (190 of FIG. 2) may identify the load of the motor and/or engine (step S41013). For example, the analyzing unit (190 of FIG. 2) may obtain the value measured by the driving device measuring unit (150 of FIG. 2) through the controller (110 of FIG. 2), thereby identifying the load of the motor and/or engine.

Next, the analyzing unit (190 of FIG. 2) may determine whether a larger load is applied than usual (step S41023). The analyzing unit (190 of FIG. 2) may compare the load obtained in step S41013 with a pre-stored first load reference value, thereby determining whether a larger load is applied than usual.

If a larger load is determined to be applied than usual in step S41023, the analyzing unit (190 of FIG. 2) may determine whether the height of the horizon is smaller than usual (step S41033). The analyzing unit (190 of FIG. 2) may grasp the height of the horizon by analyzing an image for the outside of the vehicle obtained by the camera of the sensor unit (160 of FIG. 2), by way of an AI algorithm. The analyzing unit may compare the grasped height of the horizon with a pre-stored first horizon reference value, thereby determining whether the height of the horizon is smaller than usual.

If the height of the horizon is determined to be smaller than usual in step S41033, the analyzing unit (190 of FIG. 2) may determine that the vehicle is now on an ascent (step S41043).

The game console (300 of FIG. 1 or 3) may proceed with a scenario for the ascent (step S41053). For example, the analyzing unit (190 of FIG. 2) may notify the game supporting unit (200 of FIG. 2) that the vehicle is now on the ascent, and the game supporting unit (200 of FIG. 2) may process the game data received from the game console (300 of FIG. 1 or 3) to allow the game console (300 of FIG. 1 or 3) to proceed with the scenario for the ascent and transmit the processed data to the game console (300 of FIG. 1 or 3).

Unless a larger load is determined to be applied than usual in step 41023 or the height of the horizon is determined to be larger than usual in step 41033, the analyzing unit (190 of FIG. 2) may determine whether a smaller load is applied than usual (step S41063). The analyzing unit (190 of FIG. 2) may compare the load obtained in step S41013 with a pre-stored second load reference value, thereby determining whether a larger load is applied than usual. The second load reference value may be equal or smaller than the first load reference value.

If a smaller load is determined to be applied than usual in step S41063, the analyzing unit (190 of FIG. 2) may determine whether the height of the horizon is larger than usual (step S41073). The analyzing unit (190 of FIG. 2) may grasp the height of the horizon by analyzing an image for the outside of the vehicle obtained by the camera of the sensor unit (160 of FIG. 2), by way of an AI algorithm. The analyzing unit may compare the grasped height of the horizon with a pre-stored second horizon reference value, thereby determining whether the height of the horizon is smaller than usual. The second horizon reference value may be equal or larger than the first horizon reference value.

If the height of the horizon is determined to be larger than usual in step S41073, the analyzing unit (190 of FIG. 2) may determine that the vehicle is now on a descent (step S41083).

The game console (300 of FIG. 1 or 3) may proceed with a scenario for the descent (step S41093). Proceeding with the scenario for the descent may be similar to step S41053.

Unless a smaller load is determined to be applied than usual in step 41063 or the height of the horizon is determined to be larger than usual in step 41073, the analyzing unit (190 of FIG. 2) may determine that the vehicle is on flatland (step S41103).

The game console (300 of FIG. 1 or 3) may proceed with a scenario for the flatland (step S41113). Proceeding with the scenario for the flatland may be similar to step S41053.

As described above, each step performed by the analyzing unit (190 of FIG. 2) in FIG. 12 may also be carried out by the controller (310 of FIG. 3) of the game console or the game supporting unit (200 of FIG. 2) of the game system.

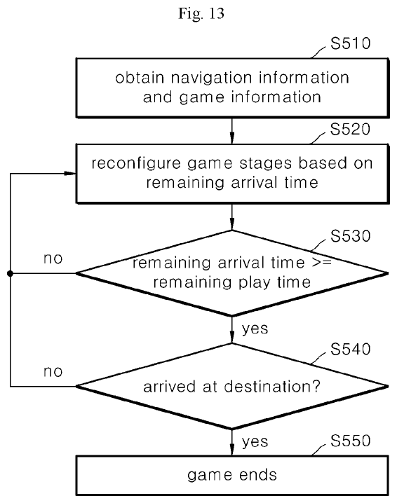

FIG. 13 is a flowchart illustrating operations of a method of changing game scenarios according to the remaining time to a destination in a method of providing a game service.

First, the analyzing unit (190 of FIG. 2) may obtain navigation information and game information (step S510). Here, the navigation information may include, e.g., information about the destination or traffic to the destination or may be the remaining arrival time which is the expected time left to the destination. The game information may be the remaining play time which is the expected time left until the game ends. The analyzing unit (190 of FIG. 2) may obtain navigation information from the navigation (170 of FIG. 2) through the controller (110 of FIG. 2) and may obtain game information from the game console (300 of FIG. 1 or 3) through the game supporting unit (200 of FIG. 2).

Next, the game stages may be reconfigured based on the remaining arrival time (step S520). Specifically, if the remaining arrival time is longer than the remaining play time, the analyzing unit (190 of FIG. 2) may notify the game supporting unit (200 of FIG. 2) of the same, and the game supporting unit (200 of FIG. 2) may process the game data received from the game console (300 of FIG. 1 or 3) so that the number of game stages increases and transmit the game data to the game console (300 of FIG. 1 or 3). As the number of game stages increases, the remaining play time of the game played on the game console (300 of FIG. 1 or 3) may increase. In some implementations, if the remaining arrival time is longer than the remaining play time, the analyzing unit (190 of FIG. 2) may notify the game supporting unit (200 of FIG. 2) of the same, and the game supporting unit (200 of FIG. 2) may process the game data received from the game console (300 of FIG. 1 or 3) so that the number of game stages decreases and transmit the game data to the game console (300 of FIG. 1 or 3). As the number of game stages decreases, the remaining play time of the game played on the game console (300 of FIG. 1 or 3) may reduce.

Next, the analyzing unit (190 of FIG. 2) may compare the remaining arrival time with the remaining play time (step S530).

If the remaining arrival time is determined to be equal or longer than the remaining play time in step S530, the analyzing unit (190 of FIG. 2) may determine whether the vehicle has arrived at the destination (step S540). Whether the vehicle has arrived at the destination may be determined based on, e.g., information received from the navigation or information received from the GPS.

If the vehicle is determined to have arrived at the destination in step S530, the game may end (step S550). For example, the analyzing unit (190 of FIG. 2) may notify the game supporting unit (200 of FIG. 2) that the vehicle has arrived at the destination, and the game supporting unit (200 of FIG. 2) may process the game data received from the game console (300 of FIG. 1 or 3) so that the game may smoothly or naturally terminate and transmit the game data to the game console (300 of FIG. 1 or 3), thereby enabling the game played on the game console (300 of FIG. 1 or 3) to terminate smoothly or naturally.

If the remaining arrival time is determined to be shorter than the remaining play time in step S530 or unless the vehicle is determined to have arrived at the destination in step S530, the procedure may go back to step S520 and be repeated.

As described above, each step performed by the analyzing unit (190 of FIG. 2) in FIG. 13 may also be carried out by the controller (310 of FIG. 3) of the game console or the game supporting unit (200 of FIG. 2) of the game system.

Some of the steps shown in the flowcharts of the disclosure may be excluded. For example, step S130 of obtaining the second data related to the game console as shown in FIG. 4 may be excluded as necessary.

What is claimed is:

1. A method of providing a game service, the method comprising:
connecting, by one or more of a game system in a vehicle and a game console, the game system and the game console;
obtaining, by one or more of the game system and the game console, first data related to the vehicle;
based on the first data, determining, by one or more of the game system and the game console, one or more of vehicle information that is related to the vehicle, vehicle driving information that is related to driving of the vehicle, and user information that is related to a user of the game console in the vehicle; and
based on the one or more of the vehicle information, the vehicle driving information, and the user information, providing, by one or more of the game system and the game console, the game service to the user of the game console through processing data related to a game played through the game console.

2. The method of claim 1, comprising:
obtaining second data related to the game console.

3. The method of claim 2, wherein:
the first data is vehicle gyroscope data measured by a first gyroscope included in the vehicle,
the second data is game console gyroscope data measured by a second gyroscope included in the game console, and
the method comprises:
determining a user seat direction that is a forward direction of the user relative to a driving direction of the vehicle by comparing the vehicle gyroscope data with the game console gyroscope data.

4. The method of claim 3, wherein providing the game service to the user of the game console comprises:
selecting a game to recommend to the user according to the user seat direction.

5. The method of claim 3, wherein providing the game service to the user of the game console comprises:
determining a likelihood of motion sickness for at least one game based on the user seat direction, a game selection screen displayed by the game console, and at least one game displayed on the game selection screen; and
displaying the likelihood of motion sickness for the at least one game on the game selection.

6. The method of claim 5, wherein:
the first data includes a user photo that is image information about the user, and
determining one or more of the vehicle information, the vehicle driving information, and the user information comprises:
determining whether the user feels motion sickness based on the user photo;
obtaining game information that is information about the game that the user plays through the game console;
learning a result of determining whether the user feels motion sickness, the game information, and the user seat direction; and
determining the likelihood of motion sickness using a result of learning the result of determining whether the user feels motion sickness, the game information, and the user seat direction.

7. The method of claim 1, wherein:
the first data includes around-vehicle image data obtained by capturing images of surroundings of the vehicle, and
providing the game service to the user of the game console comprises:
reflecting the around-vehicle image data to an environment of the game played on the game console.

8. The method of claim 7, wherein providing the game service to the user of the game console comprises:
processing the around-vehicle image data into a background screen of the game played on the game console.

9. The method of claim 1, wherein:
the first data includes vehicle gyroscope data measured by a gyroscope included in the vehicle, vehicle damper data measured by a sensor attached to a damper of the vehicle, and vehicle location data generated based on information received by a global positioning system (GPS) device included in the vehicle,
determining one or more of the vehicle information, the vehicle driving information, and the user information comprises:
generating and updating location-based road data based on the vehicle gyroscope data, the vehicle damper data, and the vehicle location data, and
providing the game service to the user of the game console comprises:
processing a game environment of the game played on the game console based on the location-based road data.

10. The method of claim 9, wherein:
the first data comprises one or more of radar measurement data, lidar measurement data, and camera measurement data, and
determining one or more of the vehicle information, the vehicle driving information, and the user information comprises:
generating and updating the location-based road data by learning a road state based on the first data.

11. The method of claim 1, wherein:
the first data comprises route data including a curvature of a location-based route and vehicle location data generated based on information received by a GPS device included in the vehicle, and
providing the game service to the user of the game console comprises:
based on the curvature being a location of the vehicle that exceeds a permitted range, reflecting the curvature to a game environment of the game played on the game console.

12. The method of claim 11, wherein:
the first data comprises one or more of radar measurement data, lidar measurement data, and camera measurement data, and
the method comprises:
determining the curvature using the first data in the location of the vehicle.

13. The method of claim 1, wherein:
the first data comprises load information that is information related to a load applied to a driving unit of the vehicle and outside-vehicle image information that is obtained by capturing an image of an outside of the vehicle, and
providing the game service to the user of the game console comprises:
determining a height of a horizon based on the outside-vehicle image information;
determining that the vehicle is on an ascent based on the load information being larger than a first load reference value and the height of the horizon being smaller than a first horizon reference value;
determining that the vehicle is on a descent based on the load information being smaller than a second load reference value that is equal or smaller than the first load reference value and the height of the horizon being larger than a second horizon reference value that is equal or larger than the first horizon reference value; and
proceeding, by the game console, with a scenario for the ascent when the vehicle is on the ascent, and proceeding, by the game console, with a scenario for the descent when the vehicle is on the descent.

14. The method of claim 2, wherein:
the first data comprises a remaining arrival time that remains until the vehicle arrives at a destination,
the second data comprises a remaining play time that remains until the game terminates, and
providing the game service to the user of the game console comprises:
comparing the remaining arrival time with the remaining play time; and
adjusting a number of stages of the game played on the game console based on comparing the remaining arrival time with the remaining play time.

15. A game system, comprising:
an analyzing unit that is configured to:
determine, based on analyzing data related to a vehicle, one or more of vehicle information that is related to the vehicle, vehicle driving information that is related to driving of the vehicle, and user information that is related to a user of a game console in the vehicle; and
a game supporting unit that is connected with the game console used by a passenger in the vehicle and that is configured to:
receive game data related to a game played on the game console;
process the game data based on one or more of the vehicle information, the vehicle driving information, and the user information; and
transmit the processed game data to the game console.

16. The game system of claim 15, wherein:
the analyzing unit is configured to determine a user seat direction that is a forward direction of the passenger relative to a driving direction of the vehicle, and
the game supporting unit is configured to process the game data to allow the game console to recommend, to the passenger, a game selected based on the user seat direction.

17. The game system of claim 15, wherein:
the analyzing unit is configured to determine a likelihood of motion sickness that is a likelihood of the passenger feeling motion sickness, based on a user seat direction that is a forward direction of the passenger relative to the driving direction of the vehicle, information about the game played on the game console, and information about whether the passenger feels motion sickness, and
the game supporting unit is configured to process the game data to display the likelihood of motion sickness for at least one game on a game selection screen based on the user seat direction, the game selection screen displayed on the game console, and the game displayed on the game selection screen.

18. The game system of claim 15, wherein:
the analyzing unit is configured to:
determine a road state in a location where the vehicle is driving based on the first data; and
provide the road state to the game supporting unit, and
the game supporting unit is configured to process the game data to allow the road state to be reflected to an environment of the game played on the game console.

19. The game system of claim 15, wherein:
the analyzing unit is configured to:
obtain image information about surroundings of the vehicle; and
provide the image information to the game supporting unit, and
the game supporting unit is configured to process the game data to allow the image information about the surroundings of the vehicle to be reflected to an environment of the game played on the game console.

20. The game system of claim 15, wherein:
the analyzing unit is configured to:
compare a remaining arrival time that remains until the vehicle arrives at a destination with a remaining play time that remains until the game terminates; and
provide, to the game supporting unit, a result of comparing the remaining arrival time with the remaining play time, and
the game supporting unit is configured to process the game data to reduce the number of stages of the game played on the game console when the remaining arrival time is shorter than the remaining play time and to increase the number of stages of the game played on the game console when the remaining arrival time is longer than the remaining play time.
